(19) United States
(12) Patent Application Publication
(10) Pub. No.: US 2017/0284879 A1
(43) Pub. Date: Oct. 5, 2017

(54) PRESSURE SENSOR, ALTIMETER, ELECTRONIC DEVICE, AND MOVING OBJECT

(71) Applicant: SEIKO EPSON CORPORATION, Tokyo (JP)

(72) Inventors: Junichi TAKEUCHI, Chino-shi (JP); Yusuke MATSUZAWA, Chino-shi (JP); Shinichi YOTSUYA, Chino-shi (JP)

(73) Assignee: SEIKO EPSON CORPORATION, Tokyo (JP)

(21) Appl. No.: 15/455,513

(22) Filed: Mar. 10, 2017

(30) Foreign Application Priority Data
Mar. 29, 2016 (JP) 2016-065210

(51) Int. Cl. G01L 7/08; G01C 5/06

(52) U.S. Cl. CPC G01L 7/088; G01C 5/06

(57) ABSTRACT

A pressure sensor includes a substrate that has a diaphragm which bends and deforms by receiving pressure and a displacement regulating unit that regulates deformation of the diaphragm, in which the diaphragm and the displacement regulating unit are spaced away from each other in a first state where the diaphragm receives pressure within a measurable range, and the diaphragm and the displacement regulating unit come into contact with each other in a second state where the diaphragm receives pressure exceeding the measurable range.

### BACKGROUND

### 1. Technical Field

The present invention relates to a pressure sensor, an altimeter, an electronic device, and a moving object.

### 2. Related Art

A configuration described in International Publication No. WO2009/041463 is known as the related art of a pressure sensor capable of detecting pressure. The pressure sensor of International Publication No. WO2009/041463 has a recessed portion, and also has an SOI substrate in which a base portion of the recessed portion is a diaphragm that bends and deforms by receiving pressure and a silicon substrate that closes an opening of the recessed portion to form a pressure reference chamber and is joined to the SOI substrate. In addition, the pressure sensor is configured such that a piezoresistive element is disposed in the diaphragm, a detection signal according to bending of the diaphragm is taken out from this piezoresistive element, and received pressure is detected based on this detection signal.

In such a pressure sensor, raising an SN ratio (signal-to-noise ratio) of output (detection signal) from the pressure sensor is required to detect pressure with even higher accuracy. For example, increasing a deformed amount of the diaphragm per unit pressure and raising the sensitivity by making the diaphragm thin so as to be bent easily are considered as means for raising the SN ratio. However, if the diaphragm is made thin, damage is likely to occur since the mechanical strength of the diaphragm declines. Accordingly, an upper limit of detectable pressure becomes lower since a withstand pressure limit (limit pressure at which the diaphragm can mechanically withstand) declines.

### SUMMARY

An advantage of some aspects of the invention is to provide a pressure sensor, which can raise pressure detection accuracy and can reduce a possibility of damage to a diaphragm, an altimeter, an electronic device, and a moving object with high reliability, all of which are provided with this pressure sensor.

The advantage can be achieved by the following configurations.

A pressure sensor according to an aspect of the invention includes a diaphragm that bends and deforms by receiving pressure and a displacement regulating unit that regulates deformation of the diaphragm, in which the diaphragm and the displacement regulating unit are spaced away from each other in a first state where the diaphragm receives pressure within a measurable range, and the diaphragm and the displacement regulating unit come into contact with each other in a second state where the diaphragm receives pressure exceeding the measurable range.

With this configuration, the pressure sensor that can raise pressure detection accuracy and reduce the possibility of damage to the diaphragm is obtained.

It is preferable that the pressure sensor according to the aspect of the invention further includes an opposing portion that is disposed so as to oppose the diaphragm such that a pressure reference chamber is formed between the diaphragm and the opposing portion, in which the displacement regulating unit is disposed on the opposing portion with respect to the diaphragm.

With this configuration, the diaphragm and the displacement regulating unit come into contact with each other more reliably at the time of the second state.

In the pressure sensor according to the aspect of the invention, it is preferable that the opposing portion also serves as the displacement regulating unit.

With this configuration, the configuration of the pressure sensor is simplified.

In pressure sensor according to the aspect of the invention, it is preferable that the displacement regulating unit is provided so as to protrude from the opposing portion toward the diaphragm.

With this configuration, a separation distance (that is, the height of the pressure reference chamber) between the diaphragm and the opposing portion can be freely designed.

In the pressure sensor according to the aspect of the invention, it is preferable that a middle portion of the diaphragm comes into contact with the displacement regulating unit in the second state.

Since the displacement amount of this middle portion of the entire diaphragm is the largest, the diaphragm and the displacement regulating unit can be brought into contact with each other more reliably at the time of the second state.

In the pressure sensor according to the aspect of the invention, it is preferable that the displacement regulating unit is positioned between the diaphragm and the opposing portion.

With this configuration, freedom in disposing the displacement regulating unit increases.

In the pressure sensor according to the aspect of the invention, it is preferable that an end portion of the diaphragm comes into contact with the displacement regulating unit in the second state.

The application of an excessive stress to the end portion can be reduced by bringing this end portion and the displacement regulating unit into contact with each other since a relatively large stress is applied to the end portion of the diaphragm when the diaphragm deforms.

In the pressure sensor according to the aspect of the invention, it is preferable that contact area reduction processing of reducing a contact area with the diaphragm is performed on a portion of the displacement regulating unit with which the diaphragm may come into contact.

With this configuration, a so-called “sticking”, in which the diaphragm and the displacement regulating unit come into contact with each other and do not separate from each other, can be reduced.

In the pressure sensor according to the aspect of the invention, it is preferable that an unevenness is formed onto the portion of the displacement regulating unit with which the diaphragm may come into contact as the contact area reduction processing.

With this configuration, the contact area can be reduced simply.

In the pressure sensor according to the aspect of the invention, it is preferable that when a separation distance between the diaphragm and the displacement regulating unit is denoted by D, a displacement amount of the diaphragm toward the displacement regulating unit in the first state is denoted by α1, and a displacement amount of the diaphragm toward the displacement regulating unit in the second state is denoted by α2, a relationship of α1<D≦α2 is satisfied.

With this configuration, the diaphragm and the displacement regulating unit can be spaced away from each other more reliably in the first state and the diaphragm and the displacement regulating unit can be brought into contact with each other more reliably in the second state.

In the pressure sensor according to the aspect of the invention, it is preferable that the thickness of a middle portion of the diaphragm is smaller than the thickness of an end portion of the diaphragm.

With this configuration, the diaphragm becomes more likely to bend while a decline in the mechanical strength of the diaphragm is suppressed.

An altimeter according to another aspect of the invention includes the pressure sensor according to the aspect of the invention.

With this configuration, the altimeter with high reliability is obtained.

An electronic device according to another aspect of the invention includes the pressure sensor according to the aspect of the invention.

With this configuration, the electronic device with high reliability is obtained.

A moving object according to another aspect of the invention includes the pressure sensor according to the aspect of the invention.

With this configuration, the moving object with high reliability is obtained.

### BRIEF DESCRIPTION OF THE DRAWINGS

The invention will be described with reference to the accompanying drawings, wherein like numbers reference like elements.

FIG. 1 is a sectional view of a pressure sensor according to a first embodiment of the invention.

FIG. 2 is a sectional view in a case where the pressure sensor illustrated in FIG. 1 is in a first state.

FIG. 3 is a sectional view in a case where the pressure sensor illustrated in FIG. 1 is in a second state.

FIG. 4 is an enlarged sectional view of a diaphragm provided in the pressure sensor illustrated in FIG. 1.

FIG. 5 is a plan view illustrating a sensor unit provided in the pressure sensor illustrated in FIG. 1.

FIG. 6 is a view illustrating a bridge circuit including the sensor unit illustrated in FIG. 5.

FIG. 7 is a sectional view of a pressure sensor according to a second embodiment of the invention.

FIG. 8 is a sectional view in a case where the pressure sensor illustrated in FIG. 7 is in the first state.

FIG. 9 is a sectional view in a case where the pressure sensor illustrated in FIG. 7 is in the second state.

FIG. 10 is a sectional view of a pressure sensor according to a third embodiment of the invention.

FIG. 11 is a sectional view of a pressure sensor according to a fourth embodiment of the invention.

FIG. 12 is a sectional view illustrating a method for manufacturing the pressure sensor illustrated in FIG. 11.

FIG. 13 is a sectional view illustrating the method for manufacturing the pressure sensor illustrated in FIG. 11.

FIG. 14 is a sectional view illustrating the method for manufacturing the pressure sensor illustrated in FIG. 11.

FIG. 15 is a sectional view illustrating the method for manufacturing the pressure sensor illustrated in FIG. 11.

FIG. 16 is a sectional view illustrating the method for manufacturing the pressure sensor illustrated in FIG. 11.

FIG. 17 is a sectional view of a pressure sensor according to a fifth embodiment of the invention.

FIG. 18 is a perspective view illustrating an example of an altimeter according to the invention.

FIG. 19 is a front view illustrating an example of an electronic device according to the invention.

FIG. 20 is a perspective view illustrating an example of a moving object according to the invention.

### DESCRIPTION OF EXEMPLARY EMBODIMENTS

Hereinafter, a pressure sensor, an altimeter, an electronic device, and a moving object according to the invention will be described in detail based on embodiments illustrated in the attached drawings.

### First Embodiment

First, a pressure sensor according to a first embodiment of the invention will be described.

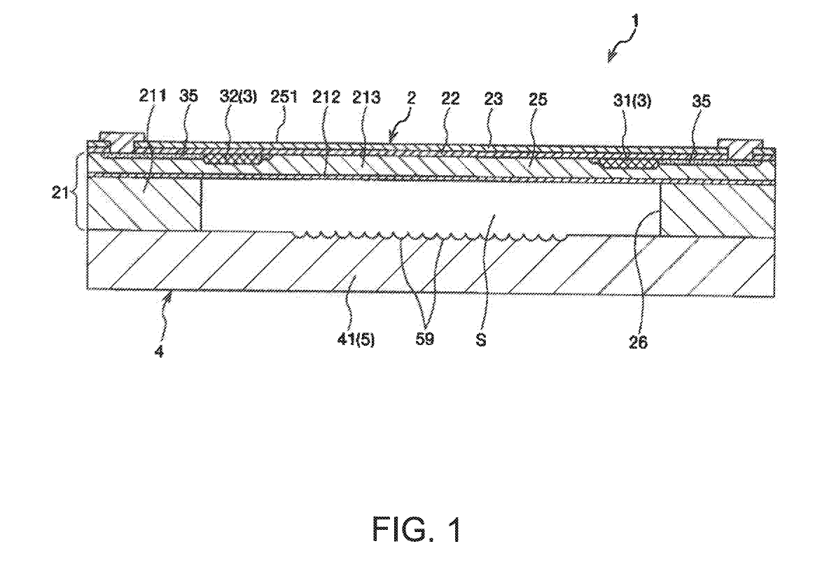

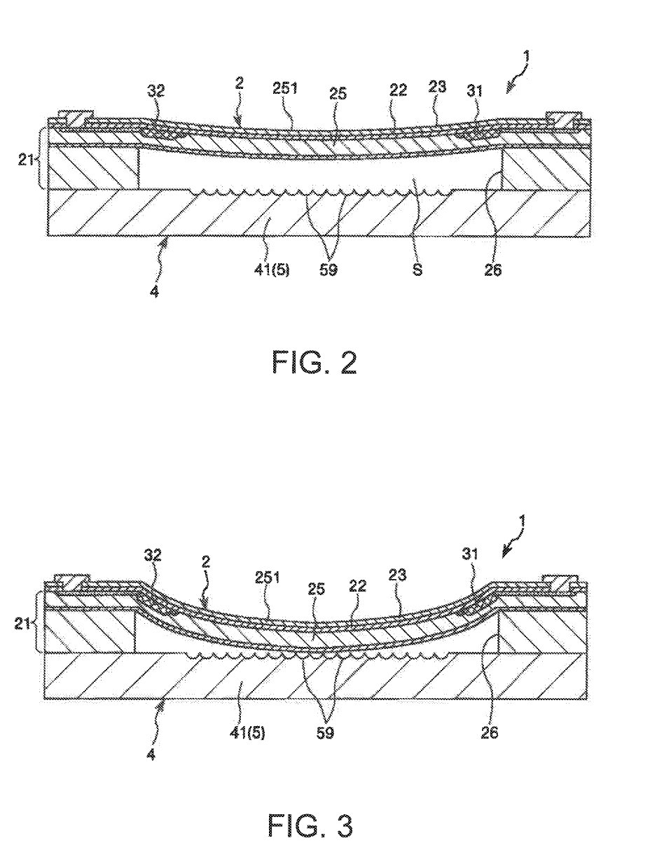

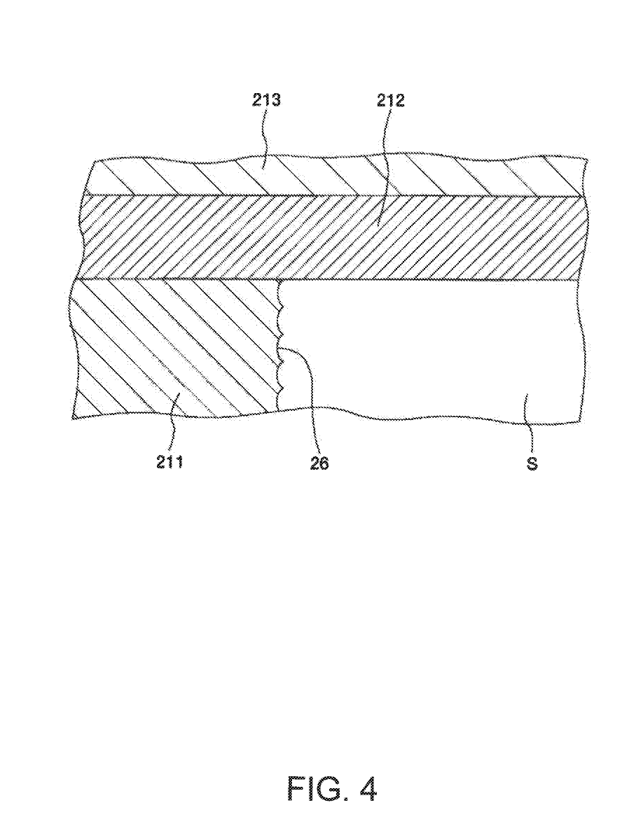

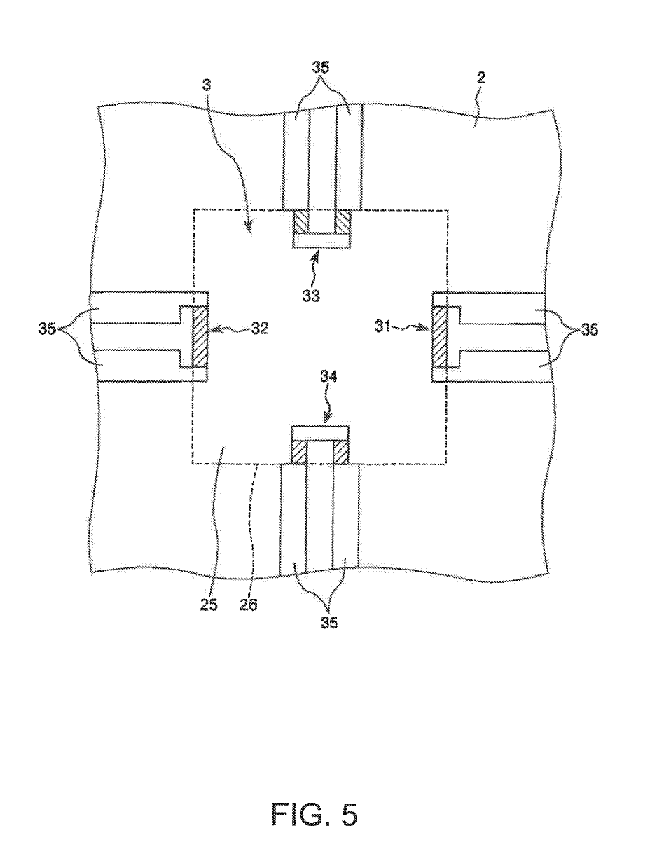

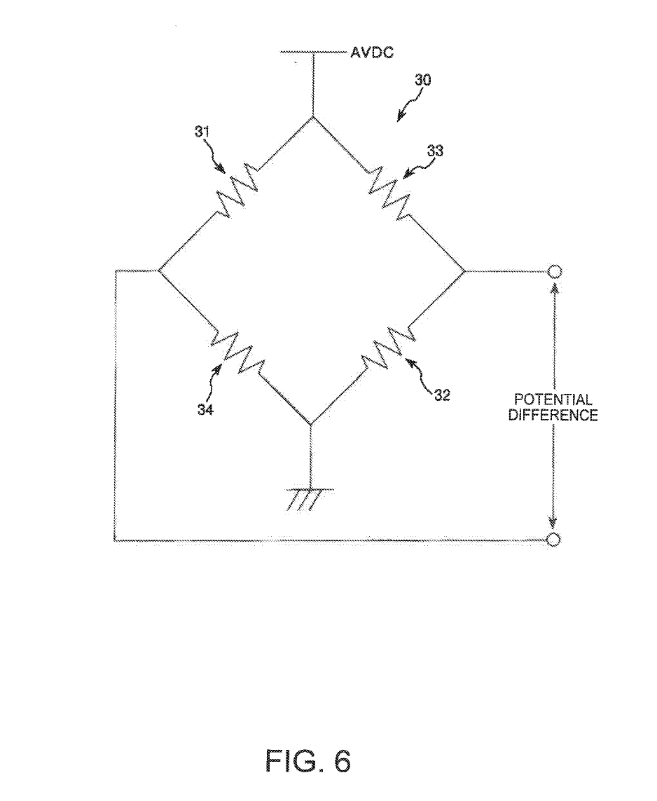

FIG. 1 is a sectional view of the pressure sensor according to the first embodiment of the invention. FIG. 2 is a sectional view in a case where the pressure sensor illustrated in FIG. 1 is in a first state. FIG. 3 is a sectional view in a case where the pressure sensor illustrated in FIG. 1 is in a second state. FIG. 4 is an enlarged sectional view of a diaphragm of the pressure sensor illustrated in FIG. 1. FIG. 5 is a plan view illustrating a sensor unit of the pressure sensor illustrated in FIG. 1. FIG. 6 is a view illustrating abridge circuit including the sensor unit illustrated in FIG. 5. In the following description, an upper side in FIG. 1 will be also referred to as “up”, and a lower side in FIG. 1 will be also referred to as “down”. In addition, a substrate 2 seen in plan view (plan view when seen from the upper side in FIG. 1) will be simply referred to as “plan view”.

A pressure sensor 1 illustrated in FIG. 1 has a diaphragm 25 that bends and deforms by receiving pressure and a displacement regulating unit 5 that regulates deformation of the diaphragm 25. Thus, such a pressure sensor 1 is configured such that the diaphragm 25 and the displacement regulating unit 5 are spaced away from each other as illustrated in FIG. 2 in the first state where the diaphragm 25 receives pressure within a measurable range and the diaphragm 25 and the displacement regulating unit 5 come into contact with each other as illustrated in FIG. 3 in the second state where the diaphragm 25 receives pressure exceeding the measurable range.

According to such a configuration, in the first state, the bending deformation of the diaphragm 25 is not regulated by the displacement regulating unit 5, the diaphragm 25 deforms according to received pressure, and thereby pressure can be accurately detected. In addition, in the second state, excessive deformation of the diaphragm 25 is restricted since the diaphragm 25 comes into contact with the displacement regulating unit 5. For this reason, the possibility of damage (deformation that is equal to or greater than a rupture limit) to the diaphragm 25 can be reduced, a decline in a withstand voltage limit (pressure limit at which the diaphragm 25 can mechanically withstand) can be restricted, and the diaphragm 25 can be made thin so as to bend easily (that is, a deformed amount of the diaphragm per unit pressure can be increased). As a result, an SN ratio of a detection signal output from the pressure sensor 1 rises and the sensitivity of the pressure sensor 1 improves. Hereinafter, such a pressure sensor 1 will be described in detail.

Such a pressure sensor 1 has the substrate 2, a sensor unit 3 disposed in the substrate 2, a base substrate 4 joined to the substrate 2, and a pressure reference chamber S (cavity portion) formed between the substrate 2 and the base substrate 4.

### Substrate

The substrate 2 has an SOI substrate 21 (that is, a substrate formed by stacking a first silicon layer 211, a silicon oxide layer 212, and a second silicon layer 213 in this order), a first insulating film 22 that is disposed on an upper surface of the SOI substrate 21 and is configured of a silicon oxide film (SiO₂ film), and a second insulating film 23 that is disposed on an upper surface of the first insulating film 22 and is configured of a silicon nitride film (SiN film). The first insulating film 22 stabilizes interface levels of piezoresistive elements 31, 32, 33, and 34, which will be described later, of the sensor unit 3, and the second insulating film 23 protects the sensor unit 3 from moisture and dust.

Instead of the SOI substrate 21, for example, a silicon substrate may be used. In addition, the first insulating film 22 and the second insulating film 23 may be configured of different materials (for example, SiON and the like) insofar as the same effects can be demonstrated. In addition, the first insulating film 22 and the second insulating film 23 may be provided if necessary, or may be omitted.

In addition, the diaphragm 25 that is thinner than surrounding portions and bends and deforms by receiving pressure is provided in the substrate 2. A bottomed recessed portion 26 that opens to a lower surface of the SOI substrate 21 is formed in the SOI substrate 21, and the diaphragm 25 is formed on a base portion of this recessed portion 26. Thus, an upper surface of the diaphragm 25 becomes a pressure receiving surface 251. The plan view shape of the diaphragm 25 is substantially a square in this embodiment, and without particularly being limited thereto, the plan view shape of the diaphragm 25 may be, for example, a circle.

In this embodiment, the recessed portion 26 is formed by dry etching by means of a silicon deep etching device. Specifically, the recessed portion 26 is formed by repeating steps of isotropic etching, protective film forming, and anisotropic etching from the lower surface of the SOI substrate 21 and by digging the first silicon layer 211. Once the silicon oxide layer 212 is reached as a result of the etching after repeating those steps, the silicon oxide layer 212 becomes an etching stopper and the etching is terminated, obtaining the recessed portion 26. By repeating the aforementioned steps, an unevenness is regularly formed in a digging direction on an inner wall side surface of the recessed portion 26 as illustrated in FIG. 4.

For this reason, the thickness of a middle portion of the diaphragm 25 is thinner than the thickness of an end portion thereof. Specifically, the thickness of the diaphragm 25 gradually decreases from the end portion to the middle portion. By forming the diaphragm 25 in such a shape, the average thickness of the diaphragm 25 can be made small. For this reason, the bent amount of the diaphragm 25 per unit pressure increases, and pressure detection sensitivity improves by the bent amount. In addition, a decline in the mechanical strength of the end portion of the diaphragm 25 can be reduced. By making the end portion of the diaphragm 25 thicker, the possibility of damage to the diaphragm 25 can be reduced since a larger stress is applied to the end portion of the diaphragm 25 than the middle portion of the diaphragm 25 once the diaphragm 25 bends and deforms by receiving pressure.

A method for forming the diaphragm. 25 is not limited to the above method, and the diaphragm 25 may be formed, for example, by wet etching.

Although the thickness (average thickness) of such a diaphragm 25 is not particularly limited, it is preferable for the diaphragm 25 to have a thickness that is equal to or larger than 1 μm and is equal to or smaller than 10 μm, and it is more preferable to have a thickness that is equal to or larger than 0.2 μm and is equal to or smaller than 10 μm. Furthermore, a thickness that is equal to or larger than 1 μm and is equal to or smaller than 5 μm is preferable, and a thickness that is equal to or larger than 0.5 μm and is equal to or smaller than 5 μm is more preferable. Furthermore, a thickness that is equal to or larger than 1 μm and is equal to or smaller than 3 μm is preferable, and a thickness that is equal to or larger than 0.5 μm and is equal to or smaller than 3 μm is more preferable. By satisfying such ranges, mechanical strength is maintained and the diaphragm 25 that is sufficiently thin and easily bends and deforms by receiving pressure is obtained.

### Sensor Unit

The sensor unit 3 has the four piezoresistive elements 31, 32, 33, and 34 provided in the diaphragm 25 as illustrated in FIG. 5. In addition, the piezoresistive elements 31, 32, 33, and 34 are electrically connected to each other via wiring 35 or the like and configure a bridge circuit 30 (Wheatstone bridge circuit) illustrated in FIG. 6. A drive circuit (not illustrated) that supplies a drive voltage AVDC is connected to the bridge circuit 30. Thus, the bridge circuit 30 outputs the detection signal (voltage) according to changes in resistance values of the piezoresistive elements 31, 32, 33, and 34 based on the bending of the diaphragm 25. For this reason, the pressure received by the diaphragm 25 can be detected based on the output detection signal.

In particular, the piezoresistive elements 31, 32, 33, and 34 are disposed along outer edges of the diaphragm 25. As in the aforementioned description, since a larger stress is applied to the end portion of the diaphragm 25 once the diaphragm 25 is bent and deformed by receiving pressure, the aforementioned detection signal can be increased and the pressure detection sensitivity improves by disposing the piezoresistive elements 31, 32, 33, and 34 in the end portion. The dispositions of the piezoresistive elements 31, 32, 33, and 34 are not particularly limited, and for example, the piezoresistive elements 31, 32, 33, and 34 may be disposed so as to straddle the outer edges of the diaphragm 25.

Each of the piezoresistive elements 31, 32, 33, and 34 is configured, for example, by the second silicon layer 213 of the SOI substrate 21 being doped (diffusion or injection) with impurities including phosphorus and boron. In addition, the wiring 35 is configured, for example, by the second silicon layer 213 of the SOI substrate 21 being doped (diffusion or injection) with impurities including phosphorus and boron at concentration higher than that of the piezoresistive elements 31, 32, 33, and 34.

### Base Substrate

The base substrate 4 is disposed so as to oppose the diaphragm 25 such that the pressure reference chamber S is formed between the diaphragm 25 and the base substrate 4. Specifically, the base substrate 4 is joined to the lower surface (outer surface of the first silicon layer 211) of the substrate 2 so as to close an opening of the recessed portion 26. Hereinafter, a portion that opposes the diaphragm 25 via the pressure reference chamber S of the base substrate 4 will be also referred to as an opposing portion 41. For example, a silicon substrate, a glass substrate, a ceramic substrate, and the like can be used as such a base substrate 4. In addition, without being particularly limited thereto, it is preferable for the base substrate 4 to have a thickness that is equal to or larger than 100 μm and is equal to or smaller than 1,000 μm. Accordingly, the deformation (in particular, bending attributable to differential pressure between pressure within the pressure reference chamber S and external pressure) of the opposing portion 41 can be restricted.

In this way, the pressure reference chamber S is formed by the recessed portion 26 being air-tightly sealed by the base substrate 4. It is preferable for the pressure reference chamber S to be a vacuum (for example, to an extent of 10 Pa or lower). Accordingly, the pressure sensor 1 can be used as a so-called “absolute pressure sensor” that detects pressure with the vacuum as a reference. For this reason, the pressure sensor 1 is highly usable. However, the pressure reference chamber S may not be in a vacuum state insofar as constant pressure (however, a pressure change due to a change in temperature is not considered) is maintained.

### Displacement Regulating Unit

The displacement regulating unit 5 is disposed on the base substrate 4 with respect to the diaphragm 25. By having such a disposition, the diaphragm 25 and the displacement regulating unit 5 can be brought into contact with each other more reliably in the second state as in the aforementioned description. In particular, in this embodiment, the opposing portion 41 of the base substrate 4 also serves as the displacement regulating unit 5 as illustrated in FIG. 1. For this reason, the displacement regulating unit 5 may not be separately provided in addition to the base substrate 4, thereby simplifying the configuration of the pressure sensor 1.

In addition, in this embodiment, the middle portion of the diaphragm 25 comes into contact with the displacement regulating unit 5 in the second state. Since the displacement amount of the middle portion becomes the largest in the entire diaphragm 25, the diaphragm 25 and the displacement regulating unit 5 can be brought into contact with each other more reliably in the second state according to such a configuration.

As in the aforementioned description, such a displacement regulating unit 5 does not come into contact with the diaphragm 25 in the first state where the diaphragm 25 receives pressure within the measurable range, and comes into contact with the diaphragm 25 in the second state where the diaphragm 25 receives pressure exceeding the measurable range. Herein, to describe the “measurable range”, the measurable range refers to a range in which pressure can be detected with at least a certain degree of accuracy (in other words, a pressure range of which detection accuracy is guaranteed or of which use is recommended by a manufacturer or a provider of the pressure sensor 1. For example, the measurable range is a detected pressure accuracy guaranteed range written in a specification of the pressure sensor 1. In addition, the measurable range may be a pressure range of the maximum rating or the absolute maximum rating and may include a pressure range in which the pressure sensor 1 can repeatedly operate normally), and this range may be set for each pressure sensor 1. In addition, in recent years, a demand for a pressure sensor capable of detecting up to approximately ten atmospheric pressures (that is, a depth of approximately 100 m) has risen. For this reason, it is preferable for such a measurable range to be equal to or larger than zero atmospheric pressure and be equal to or smaller than five atmospheric pressures, it is more preferable to be equal to or larger than zero atmospheric pressure and be equal to or smaller than eight atmospheric pressures, and it is even more preferable to be equal to or larger than zero atmospheric pressure and be equal to or smaller than ten atmospheric pressures.

Herein, although pressure at which actual contact occurs is not particularly limited when the diaphragm 25 and the displacement regulating unit 5 come into contact with each other in the second state, it is preferable that the diaphragm 25 and the displacement regulating unit 5 come into contact with each other at pressure (that is, pressure that exceeds the upper limit of the measurable range but is closer to the upper limit) as low as possible. Specifically, it is preferable that the diaphragm 25 and the displacement regulating unit 5 come into contact with each other once pressure that is larger than the upper limit of the measurable range by an amount equal to or less than one atmospheric pressure is received. Accordingly, excessive deformation of the diaphragm 25 is more effectively restricted, and thus the possibility of damage to the diaphragm 25 can be more effectively reduced. However, once the pressure at which the diaphragm 25 and the displacement regulating unit 5 come into contact with each other reaches too close to the upper limit of the measurable range, the diaphragm 25 and the displacement regulating unit 5 might come into contact with each other at pressure (that is, first state) that is equal to or smaller than the upper limit of the measurable range depending on a use environment temperature of the pressure sensor 1 or an individual difference of the pressure sensor 1. At that time, it is preferable that the diaphragm 25 and the displacement regulating unit 5 do not come into contact with each other at least at pressure that is larger than the upper limit of the measurable range by an amount equal to or less than 0.1 atmospheric pressures. In other words, it is preferable that the upper limit of the measurable range be set to pressure which is at least 0.1 atmospheric pressures smaller than the pressure at which the diaphragm 25 and the displacement regulating unit 5 come into contact with each other.

In addition, the pressure sensor 1 satisfies a relationship of α1<D≦α2 when a separation distance (that is, the height of the pressure reference chamber S) between the diaphragm 25 and the displacement regulating unit 5 in a state where the external pressure is equal to the pressure of the pressure reference chamber S is denoted by D, a displacement amount of the diaphragm 25 toward the displacement regulating unit 5 in the first state is denoted by α1, and a displacement amount of the diaphragm 25 toward the displacement regulating unit 5 in the second state is denoted by α2. By satisfying such a relationship, the diaphragm 25 and the displacement regulating unit 5 can be spaced away from each other more reliably in the first state and the diaphragm 25 and the displacement regulating unit 5 can be brought into contact with each other more reliably in the second state.

When pressure received by the pressure sensor 1 is denoted by P, the width (in this embodiment, the length of one side since the diaphragm 25 is substantially a square) of the diaphragm 25 is denoted by a, the thickness of the diaphragm 25 is denoted by t0, and the Young's modulus of the diaphragm 25 is denoted by E0, a deformed amount Z of the diaphragm 25 toward the displacement regulating unit 5 attributable to the pressure P can be expressed as the following Equation (1) (however, the unit of each value is SI unit). For this reason, when the pressure of the first state is substituted in for the pressure P, the aforementioned α1 is acquired as the deformed amount Z, and similarly when the pressure of the second state is substituted in for the pressure P, the aforementioned α2 is acquired as the deformed amount Z.

$$Z = \frac{0.0138 \times P \times {a}^{4}}{E 0 \times {to}^{3}} \qquad ( 1 )$$

The base substrate 4 does not substantially deform since the base substrate 4 is formed to be sufficiently thick, and in the above description, the bending of the displacement regulating unit 5 (opposing portion 41) toward the diaphragm 25 attributable to the external pressure is not considered. In a case where the displacement regulating unit 5 bends towards the diaphragm 25 due to the external pressure, it is preferable that a relationship of α1+β1<D≦α2+β2 is satisfied when the displacement amount of the displacement regulating unit 5 towards the diaphragm 25 in the first state is denoted by β1 and the displacement amount of the displacement regulating unit 5 towards the diaphragm 25 in the second state is denoted by β2.

In addition, contact area reduction processing of reducing the contact area with the diaphragm 25 is performed on a portion (that is, the upper surface of the displacement regulating unit 5) of the displacement regulating unit 5 with which the diaphragm 25 may come into contact. For this reason, the possibility of the occurrence of a so-called “sticking”, in which the diaphragm 25 and the displacement regulating unit 5 do not separate from each other when the diaphragm 25 and the displacement regulating unit 5 have come into contact with each other in the second state, can be reduced. In particular, in this embodiment, as the contact area reduction processing, an unevenness is formed onto the portion of the displacement regulating unit 5 with which the diaphragm 25 may come into contact. Accordingly, the contact area can be reduced simply. The unevenness is obtained by forming a plurality of recessed portions 59 in the lower surface of the displacement regulating unit 5.

### Second Embodiment

Next, a pressure sensor according to a second embodiment of the invention will be described.

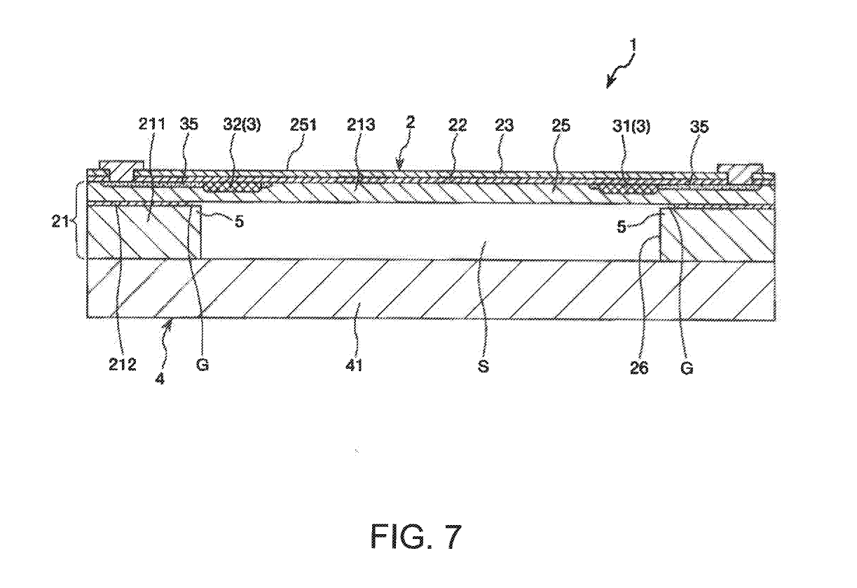

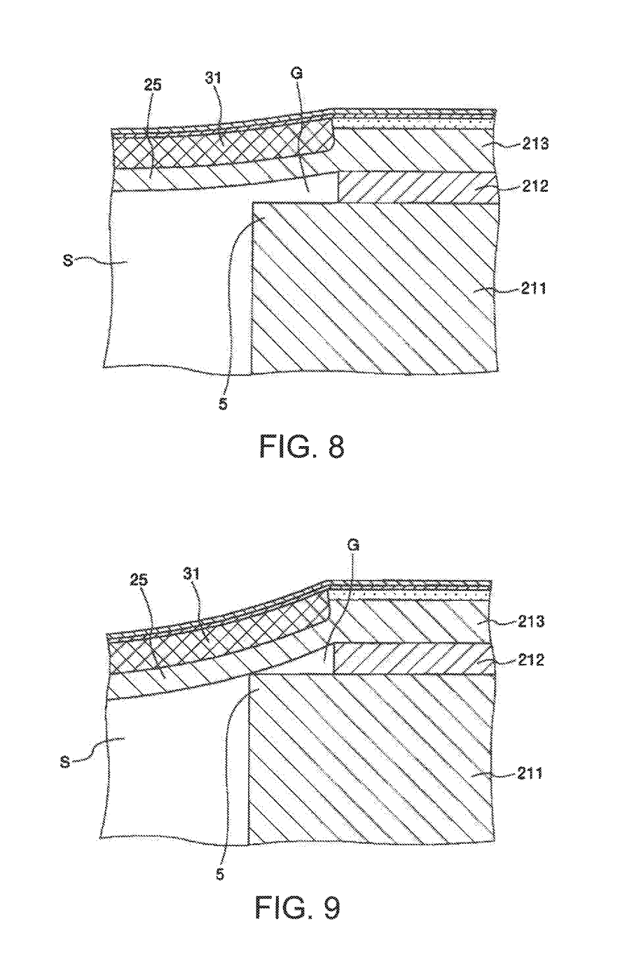

FIG. 7 is a sectional view of the pressure sensor according to the second embodiment of the invention. FIG. 8 is a sectional view in a case where the pressure sensor illustrated in FIG. 7 is in the first state. FIG. 9 is a sectional view in a case where the pressure sensor illustrated in FIG. 7 is in the second state.

Hereinafter, the pressure sensor of the second embodiment will be described, focusing on points different from the aforementioned embodiment, and description for the same points will be omitted.

The pressure sensor of the second embodiment is the same as that of the aforementioned first embodiment except for the configuration of the displacement regulating unit. The same configurations as those of the aforementioned embodiment will be assigned with the same reference numerals.

In the pressure sensor 1 of this embodiment, the silicon oxide layer 212 is removed from the lower surface of the diaphragm 25 as illustrated in FIG. 7. By having such a configuration, the diaphragm 25 can be made thinner, for example, compared to the configuration of the aforementioned first embodiment. For this reason, the pressure sensor 1 with even higher sensitivity is obtained.

In this embodiment, as in the aforementioned first embodiment, the recessed portion 26 is formed by the dry etching by means of the silicon deep etching device, and after then, the diaphragm 25 is formed by removing the silicon oxide layer 212, which is the base portion of the recessed portion 26, by isotropic wet etching. Since the silicon oxide layer 212 is side-etched by this wet etching, the silicon oxide layer 212 is removed to an outer side of the first silicon layer 211. For this reason, a clearance G between the diaphragm 25 and the first silicon layer 211 is formed.

In such a configuration, a portion opposing the diaphragm 25 via the clearance G of the first silicon layer 211 configures the displacement regulating unit 5. Therefore, the diaphragm 25 and the displacement regulating unit 5 are spaced away from each other in the first state as illustrated in FIG. 8, and the diaphragm 25 and the displacement regulating unit 5 have come into contact with each other in the second state as illustrated in FIG. 9. For this reason, even in the pressure sensor 1 of this embodiment, pressure detection accuracy can be raised and the possibility of damage to the diaphragm 25 can be reduced, as in the aforementioned first embodiment.

In this embodiment, the displacement regulating unit 5 is disposed as a member separate from the base substrate 4, which is an opposing portion, and is positioned between the diaphragm 25 and the base substrate 4. In this way, by disposing the displacement regulating unit 5 between the diaphragm 25 and the base substrate 4, freedom in disposing the displacement regulating unit 5 increases. In addition, the separation distance (that is, the height of the pressure reference chamber) between the base substrate 4 and the diaphragm 25 can be freely set. In addition, as illustrated in FIG. 9, the end portion of the diaphragm 25 is made to come into contact with the displacement regulating unit 5 in the second state. As in the aforementioned description, the application of an excessive stress to the end portion of the diaphragm 25 can be reduced by bringing this end portion and the displacement regulating unit 5 into contact with each other since a relatively large stress is applied to the end portion of the diaphragm 25 at a time of the deformation of the diaphragm 25. For this reason, the possibility of damage to the diaphragm 25 can be more effectively reduced.

The same effects as those of the aforementioned first embodiment can be demonstrated in such a second embodiment as well. In this embodiment, the recessed portion 59 described in the aforementioned first embodiment is omitted from the base substrate 4.

### Third Embodiment

Next, a pressure sensor according to a third embodiment of the invention will be described.

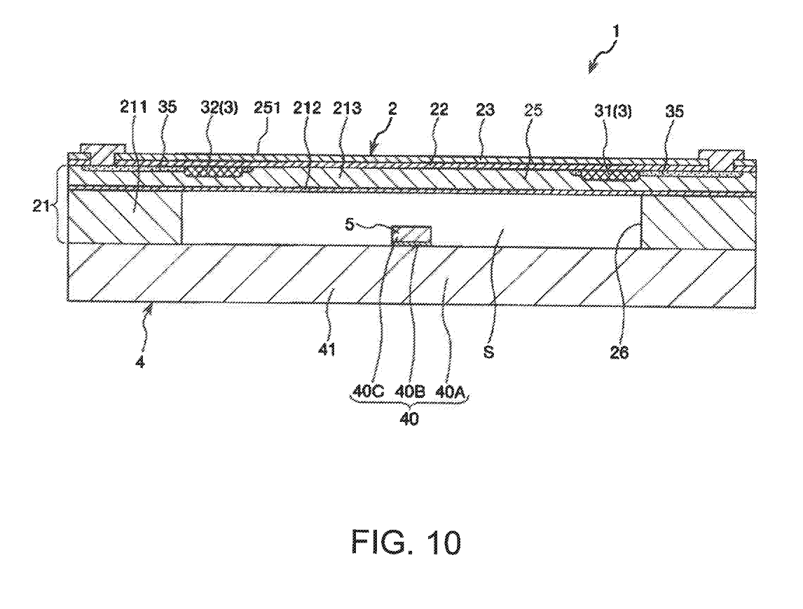

FIG. 10 is a sectional view of the pressure sensor according to the third embodiment of the invention.

Hereinafter, the pressure sensor of the third embodiment will be described, focusing on points different from the aforementioned embodiment, and description for the same points will be omitted.

The pressure sensor of the third embodiment is the same as that of the aforementioned first embodiment except for the configuration of the displacement regulating unit. The same configurations as those of the aforementioned embodiment will be assigned with the same reference numerals.

In the pressure sensor 1 of this embodiment, the displacement regulating unit 5 is provided so as to protrude from the base substrate 4, which is the opposing portion, toward the diaphragm 25 (within the pressure reference chamber S) as illustrated in FIG. 10. Accordingly, the separation distance (that is, the height of the pressure reference chamber S) between the diaphragm 25 and the base substrate 4 can be freely designed.

In this embodiment, the displacement regulating unit 5 and the base substrate 4 are formed so as to be integrated with an SOI substrate 40. That is, the SOI substrate 40 is a substrate formed by stacking a first silicon layer 40A, a silicon oxide layer 40B, and a second silicon layer 40C, the displacement regulating unit 5 is formed of the second silicon layer 40C and the silicon oxide layer 40B out of these three layers, and the base substrate 4 is formed of the first silicon layer 40A. According to such a configuration, the displacement regulating unit 5 can be formed relatively simply using a semiconductor process. Without being limited to the above configuration, the configuration of the displacement regulating unit 5 may be a configuration, for example, in which the displacement regulating unit 5 prepared separately from the base substrate 4 is joined to the base substrate 4 via an adhesive or the like.

The same effects as those of the aforementioned first embodiment can be demonstrated in such a third embodiment as well. The contact area reduction processing described in the first embodiment may be performed on the upper surface (portion with which the diaphragm 25 may come into contact) of the displacement regulating unit 5.

### Fourth Embodiment

Next, a pressure sensor according to a fourth embodiment of the invention will be described.

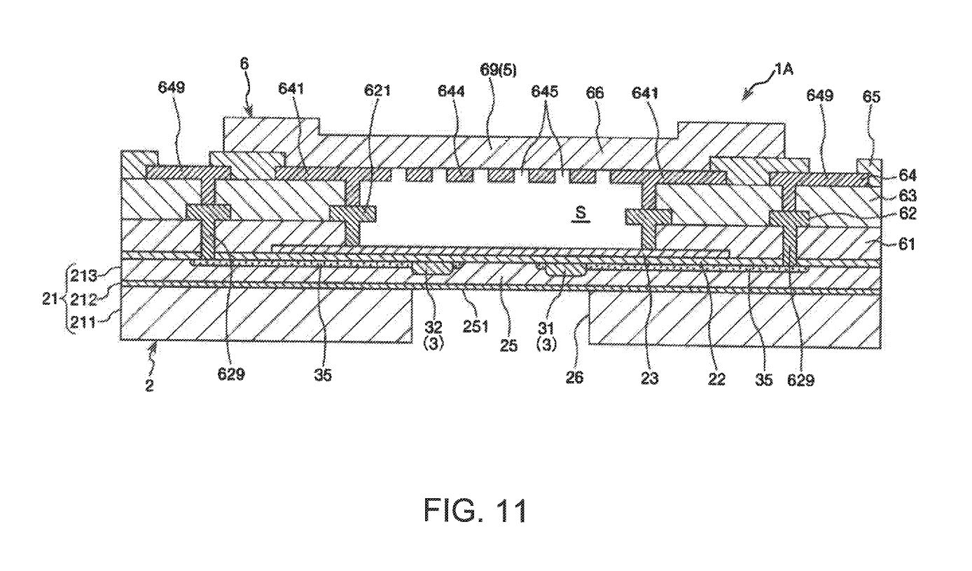

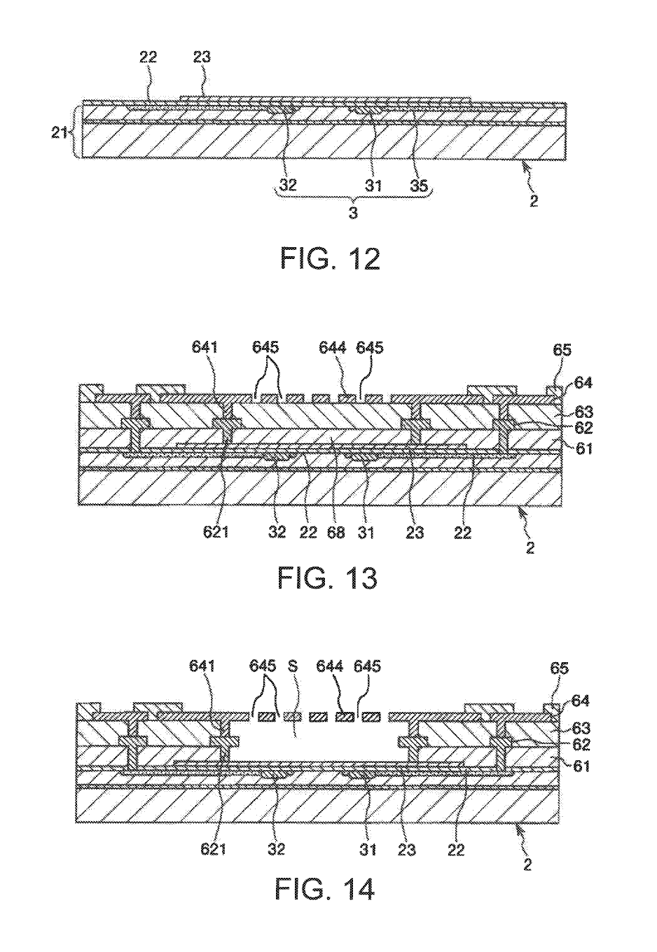

FIG. 11 is a sectional view of the pressure sensor according to the fourth embodiment of the invention. Each of FIG. 12 to FIG. 16 is a sectional view illustrating a method for manufacturing the pressure sensor illustrated in FIG. 11.

Hereinafter, the pressure sensor of the fourth embodiment will be described, focusing on points different from the aforementioned embodiment, and description for the same points will be omitted.

A pressure sensor 1A illustrated in FIG. 11 has the substrate 2, the sensor unit 3, a surrounding structure 6, and the pressure reference chamber S (cavity portion). Since each configuration of the substrate 2, the sensor unit 3, and the pressure reference chamber S is the same as in the aforementioned first embodiment, the surrounding structure 6 will be mainly described hereinafter.

### Surrounding Structure

The surrounding structure 6 forms the pressure reference chamber S with the substrate 2. Such a surrounding structure 6 has an interlayer insulating film 61 disposed on the substrate 2, a wiring layer 62 disposed on the interlayer insulating film 61, an interlayer insulating film 63 disposed on the wiring layer 62 and the interlayer insulating film 61, a wiring layer 64 disposed on the interlayer insulating film 63, an outer surface protective film 65 disposed on the wiring layer 64 and the interlayer insulating film 63, and a sealing layer 66 disposed on the wiring layer 64 and the outer surface protective film 65.

The wiring layer 62 has a frame-shaped wiring unit 621 disposed so as to enclose the pressure reference chamber S and a wiring unit 629 connected to the wiring 35 of the sensor unit 3. Similarly, the wiring layer 64 has a frame-shaped wiring unit 641 disposed so as to enclose the pressure reference chamber S and a wiring unit 649 connected to the wiring 35. Thus, the sensor unit 3 is pulled out to an upper surface of the surrounding structure 6 by the wiring units 629 and 649.

In addition, the wiring layer 64 has a coating layer 644 positioned on the ceiling of the pressure reference chamber S. In addition, a plurality of through-holes 645 that communicate with an inside and an outside of the pressure reference chamber S are disposed in the coating layer 644. Such a coating layer 644 is formed so as to be integrated with the wiring unit 641, and is disposed so as to oppose the diaphragm 25 such that the pressure reference chamber S is interposed therebetween. The plurality of through-holes 645 are holes for release etching in which an etching solution is infiltrated into the pressure reference chamber S, as will be explained later in the method for manufacturing. In addition, the sealing layer 66 is disposed on the coating layer 644, and the through-holes 645 are sealed by this sealing layer 66.

In such a configuration, the portion of a stacked structure of the coating layer 644 and the sealing layer 66 opposing the diaphragm 25 via the pressure reference chamber S, configures an opposing portion 69. Furthermore, this opposing portion 69 also serves as the displacement regulating unit 5. For this reason, the middle portion of the diaphragm 25 deformed toward the pressure reference chamber S comes into contact with the opposing portion 69 (displacement regulating unit 5) in the second state.

The outer surface protective film 65 has a function of protecting the surrounding structure 6 from moisture, dirt, and a scratch. Such an outer surface protective film 65 is disposed on the interlayer insulating film 63 and the wiring layer 64 so as not to close the through-holes 645 of the coating layer 644.

For example, insulating films including a silicon oxide film (SiO₂ film) can be used as the interlayer insulating films 61 and 63 of such a surrounding structure 6. In addition, for example, metal films including an aluminum film can be used as the wiring layers 62 and 64. In addition, for example, a metal film, which is made of Al, Cu, W, Ti, TiN, or the like, and a silicon oxide film can be used as the sealing layer 66. In addition, for example, the silicon oxide film, the silicon nitride film, a polyimide film, an epoxy resin film, or the like can be used as the outer surface protective film 65.

Next, a method for manufacturing the pressure sensor 1A will be described. The method for manufacturing the pressure sensor 1A has a sacrificial layer disposing step of disposing a sacrificial layer 68 onto the substrate 2, a pressure reference chamber forming step of forming the pressure reference chamber S by removing the sacrificial layer 68, and a diaphragm forming step of forming the diaphragm 25.

### Sacrificial Layer Disposing Step

First, as illustrated in FIG. 12, the sensor unit 3 is formed by preparing the SOI substrate 21 and injecting impurities including phosphorus and boron into the SOI substrate 21. Next, the first insulating film 22 and the second insulating film 23 are formed onto the SOI substrate 21 in this order by using a sputtering method, a CVD method, and the like. Accordingly, the substrate 2 in which the diaphragm 25 is not formed is obtained.

Next, as illustrated in FIG. 13, the interlayer insulating film 61, the wiring layer 62, the interlayer insulating film 63, the wiring layer 64, and the outer surface protective film 65 are formed onto the substrate 2 in this order by using the sputtering method, the CVD method, and the like. Accordingly, the sacrificial layer 68 enclosed with the wiring units 621 and 641 and the coating layer 644 that coats the sacrificial layer 68 from the upside are formed.

### Pressure Reference Chamber Forming Step

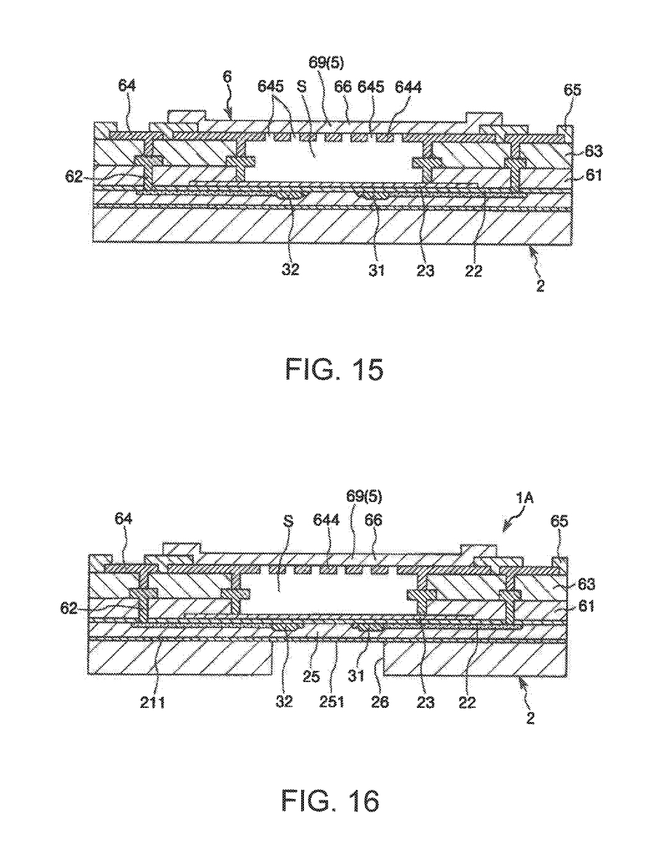

Next, the substrate 2 is exposed to, for example, the etching solution including buffered hydrofluoric acid after protecting the outer surface protective film 65 with a resist mask (not illustrated). Accordingly, the sacrificial layer 68 is removed via the through-holes 645, and the pressure reference chamber S is formed as illustrated in FIG. 14. Next, the pressure reference chamber S is brought to a vacuum state and the sealing layer 66 is formed onto the coating layer 644 by using the sputtering method, the CVD method, and the like to seal the pressure reference chamber S as illustrated in FIG. 15. Accordingly, the opposing portion 69 which also serves as the displacement regulating unit 5 is obtained.

### Diaphragm Forming Step

Next, as illustrated in FIG. 16, the recessed portion 26 is formed in the lower surface of the substrate 2 by the dry etching by means of the silicon deep etching device to form the diaphragm 25. According to the above steps, the pressure sensor 1A is obtained.

The same effects as those of the aforementioned first embodiment can be demonstrated in such a fourth embodiment as well.

### Fifth Embodiment

Next, a pressure sensor according to a fifth embodiment of the invention will be described.

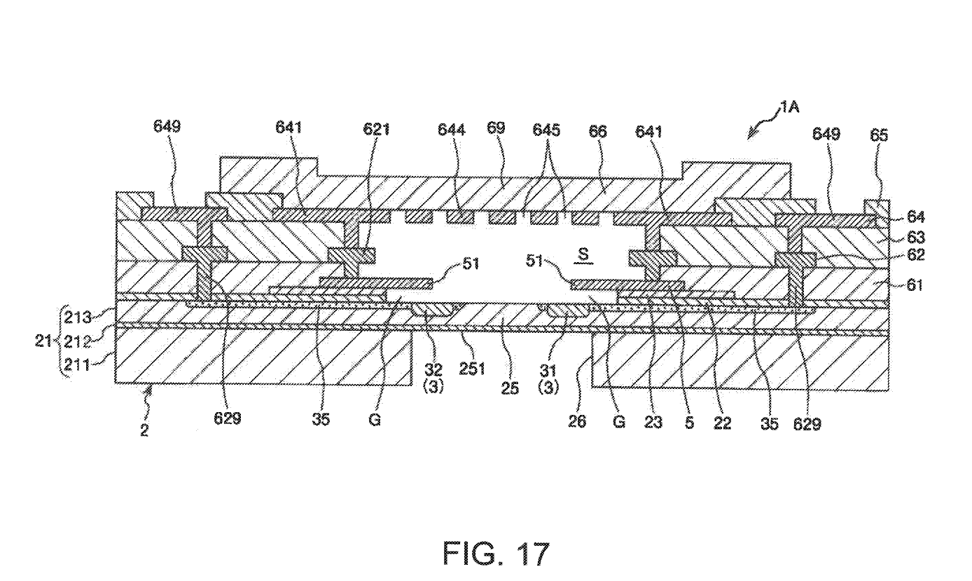

FIG. 17 is a sectional view of the pressure sensor according to the fifth embodiment of the invention.

Hereinafter, the pressure sensor of the fifth embodiment will be described, focusing on points different from the aforementioned embodiment, and description for the same points will be omitted.

The pressure sensor of the fifth embodiment is the same as that of the aforementioned fourth embodiment except for the configuration of the displacement regulating unit. The same configurations as those of the aforementioned embodiment will be assigned with the same reference numerals.

In the pressure sensor 1A illustrated in FIG. 17, the first insulating film 22 and the second insulating film 23 are not provided on the diaphragm 25. That is, the first insulating film 22 and the second insulating film 23 are disposed such that the upper surface of the diaphragm 25 is left out. By having such a configuration, the diaphragm 25 can be made thinner, for example, compared to the configuration of the aforementioned fourth embodiment. For this reason, the pressure sensor 1A with even higher sensitivity is obtained.

In addition, the pressure sensor 1A has the annular (ring-shaped) displacement regulating unit 5 that is disposed on the second insulating film 23 and is provided so as to extrude toward the inside of the pressure reference chamber S. Thus, an end portion 51 of the displacement regulating unit 5 on the pressure reference chamber S opposes the end portion of the diaphragm 25 via the clearance G formed by the first and second insulating films 22 and 23. For this reason, the end portion of the diaphragm 25 deformed on the pressure reference chamber S comes into contact with the end portion 51 of the displacement regulating unit 5 in the second state. The configuration material for the displacement regulating unit 5 is not particularly limited, and, for example, polysilicon can be used. By using polysilicon, the displacement regulating unit 5 can be formed simply by the method for manufacturing in which the semiconductor process of the aforementioned fourth embodiment is used.

The same effects as those of the aforementioned first embodiment can be demonstrated in such a fifth embodiment as well. As a modification example of this embodiment, for example, a portion that extrudes toward the inside of the pressure reference chamber S of the wiring unit 621 may be used as the displacement regulating unit 5.

### Sixth Embodiment

Next, an altimeter according to a sixth embodiment of the invention will be described.

FIG. 18 is a perspective view illustrating an example of the altimeter according to the invention.

An altimeter 200 illustrated in FIG. 18 can be worn around the wrist as a wrist watch. In addition, the aforementioned pressure sensor 1 is mounted in the altimeter 200, and the altitude above sea level of the present location and the atmospheric pressure of the present location can be displayed on a display unit 201. In addition to the aforementioned information, this display unit 201 can display various types of information including current time, heart rate of the user, and weather. Since such an altimeter 200 has the pressure sensor 1 which is excellent in terms of detection accuracy, high reliability can be demonstrated. Instead of the pressure sensor 1, the altimeter 200 may be provided with the pressure sensor 1A.

If such an altimeter 200 is waterproof, the altimeter 200 can be used as, for example, a depth gauge for diving and free diving.

### Seventh Embodiment

Next, an electronic device according to a seventh embodiment of the invention will be described.

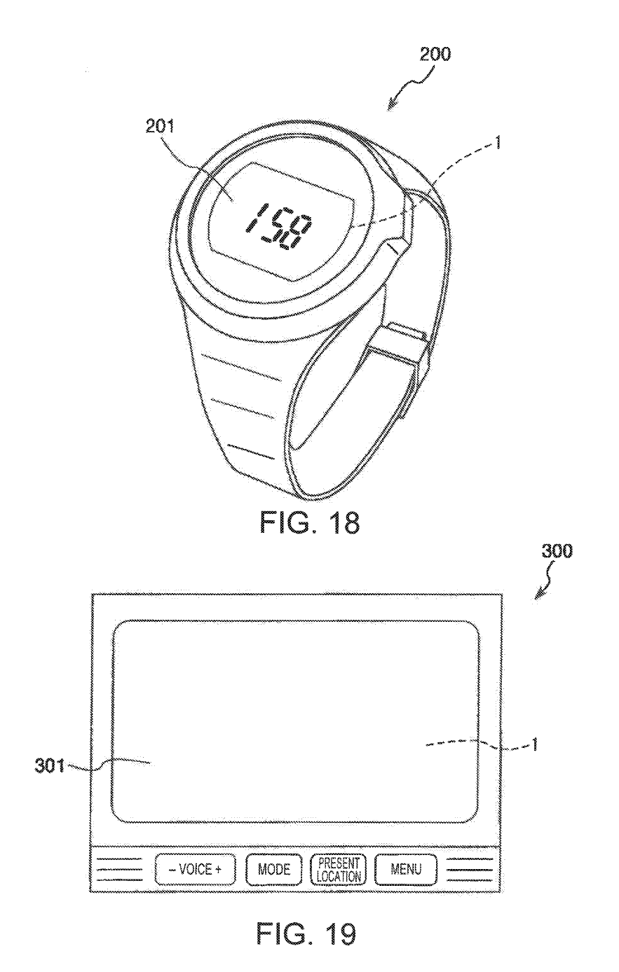

FIG. 19 is a front view illustrating an example of the electronic device according to the invention.

The electronic device illustrated in FIG. 19 is a navigation system 300 provided with the aforementioned pressure sensor 1. The navigation system 300 is provided with cartographic information (not illustrated), location information from the Global Positioning System (GPS) acquisition means, autonomous navigation means based on a gyro sensor, an acceleration sensor, and vehicle speed data, the pressure sensor 1, and a display unit 301 that displays predetermined location information or course information.

According to this navigation system 300, in addition to the acquired location information, altitude information can be acquired by the pressure sensor 1. For this reason, by detecting an altitude change caused by entering an overpass from a general road (or vice versa), it can be determined whether the general road is being travelled or the overpass is being travelled and the user can be provided with navigation information under an actual travelling state. Since such a navigation system 300 has the pressure sensor 1 excellent in terms of detection accuracy, high reliability can be demonstrated. Instead of the pressure sensor 1, the navigation system 300 may be provided with the pressure sensor 1A.

The electronic device provided with the pressure sensor according to the invention is not limited to the above navigation system, and the pressure sensor can be applied to, for example, a personal computer, a mobile phone, a smartphone, a tablet terminal, a wearable terminal, a watch (including a smartwatch), a medical device (for example, an electronic thermometer, a sphygmomanometer, a glucose meter, an electrocardiogram measuring device, an ultrasound diagnostic device, and an electronic endoscope), various measuring devices, an instrument (for example, instruments of a vehicle, an airplane, and a ship), a flight simulator, and the like.

### Eighth Embodiment

Next, a moving object according to an eighth embodiment of the invention will be described.

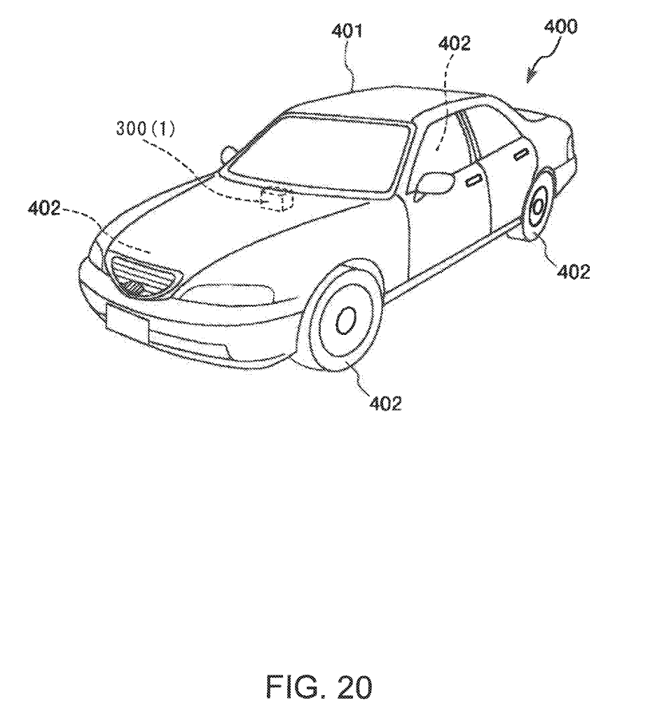

FIG. 20 is a perspective view illustrating an example of the moving object according to the invention.

The moving object illustrated in FIG. 20 is an automobile 400 provided with the aforementioned pressure sensor 1. The automobile 400 has a vehicle body 401 and four wheels 402, and is configured such that the wheels 402 are rotated by a power source (engine) (not illustrated) provided in the vehicle body 401. Since such an automobile 400 has the pressure sensor 1 excellent in terms of detection accuracy, high reliability can be demonstrated. Instead of the pressure sensor 1, the automobile 400 may be provided with the pressure sensor 1A.

Hereinbefore, although the pressure sensor, the altimeter, the electronic device, and the moving object according to the invention have been described based on each illustrated embodiment, the invention is not limited to the aforementioned devices. The configuration of each unit can be replaced with any configuration having the same function. In addition, any other configuration element and step may be added. In addition, each embodiment may be appropriately combined.

In addition, although it has been described that the piezoresistive element is used as the sensor unit in the aforementioned embodiment, the pressure sensor is not limited thereto. For example, a configuration in which a flap type oscillator is used, a configuration in which other MEMS oscillator including a comb-teeth electrode is used, or a configuration in which an oscillation element including a crystal oscillator is used can also be used.

The entire disclosure of Japanese Patent Application No. 2016-065210, filed Mar. 29, 2016 is expressly incorporated by reference herein.

What is claimed is:

1. A pressure sensor comprising:
a diaphragm that bends and deforms by receiving pressure; and
a displacement regulating unit that regulates deformation of the diaphragm,
wherein the diaphragm and the displacement regulating unit are spaced away from each other in a first state where the diaphragm receives pressure within a measurable range, and
the diaphragm and the displacement regulating unit come into contact with each other in a second state where the diaphragm receives pressure exceeding the measurable range.

2. The pressure sensor according to claim 1, further comprising:
an opposing portion that is disposed so as to oppose the diaphragm such that a pressure reference chamber is formed between the diaphragm and the opposing portion,
wherein the displacement regulating unit is disposed on the opposing portion with respect to the diaphragm.

3. The pressure sensor according to claim 2,
wherein the opposing portion also serves as the displacement regulating unit.

4. The pressure sensor according to claim 3,
wherein the displacement regulating unit is provided so as to protrude from the opposing portion toward the diaphragm.

5. The pressure sensor according to claim 3,
wherein a middle portion of the diaphragm comes into contact with the displacement regulating unit in the second state.

6. The pressure sensor according to claim 2,
wherein the displacement regulating unit is positioned between the diaphragm and the opposing portion.

7. The pressure sensor according to claim 6,
wherein an end portion of the diaphragm comes into contact with the displacement regulating unit in the second state.

8. The pressure sensor according to claim 1,
wherein contact area reduction processing of reducing a contact area with the diaphragm is performed on a portion of the displacement regulating unit with which the diaphragm may come into contact.

9. The pressure sensor according to claim 8,
wherein an unevenness is formed onto the portion of the displacement regulating unit with which the diaphragm may come into contact as the contact area reduction processing.

10. The pressure sensor according to claim 5,
wherein when a separation distance between the diaphragm and the displacement regulating unit is denoted by D,
a displacement amount of the diaphragm toward the displacement regulating unit in the first state is denoted by α1, and
a displacement amount of the diaphragm toward the displacement regulating unit in the second state is denoted by α2,
a relationship of α1<D≦α2 is satisfied.

11. The pressure sensor according to claim 1,
wherein the thickness of a middle portion of the diaphragm is smaller than the thickness of an end portion of the diaphragm.

12. An altimeter comprising the pressure sensor according to claim 1.

13. An altimeter comprising the pressure sensor according to claim 2.

14. An altimeter comprising the pressure sensor according to claim 3.

15. An electronic device comprising the pressure sensor according to claim 1.

16. An electronic device comprising the pressure sensor according to claim 2.

17. An electronic device comprising the pressure sensor according to claim 3.

18. A moving object comprising the pressure sensor according to claim 1.

19. A moving object comprising the pressure sensor according to claim 2.

20. A moving object comprising the pressure sensor according to claim 3.
